(19) United States
(12) Patent Application Publication
(10) Pub. No.: US 2016/0267819 A1
(43) Pub. Date: Sep. 15, 2016

(54) MATTRESS DISPLAY WITH A REMOVABLE PORTION

(71) Applicant: COLONIAL, LLC, High Point, NC (US)

(72) Inventor: Wesley Ray Keever, High Point, NC (US)

(21) Appl. No.: 15/161,324

(22) Filed: May 23, 2016

Related U.S. Application Data
(63) Continuation of application No. 13/660,128, filed on Oct. 25, 2012.

(51) Int. Cl. G09F 7/02; G09F 23/00; A47G 9/02

(52) U.S. Cl. CPC G09F 7/02; A47G 9/0253; G09F 23/00

(57) ABSTRACT

A mattress display with a removable portion is provided. A mattress display is typically used for the showing and/or selling of a mattress. A removable portion may be affixed to the mattress display with an attachment means, such as a zipper, or the like. Information associated with the mattress being sold may be permanently or temporarily displayed on the removable portion in a manner such that the information is visible to customers. Furthermore, the removable portion may be completely removed from the display and subsequently a different removable portion may be added to include updated information associated with the mattress without the need to replace the entire mattress display.

### CROSS-REFERENCE TO RELATED APPLICATIONS

This application is a continuation of U.S. patent application Ser. No. 13/660,128, filed Oct. 25, 2012 of the same title, the entirety of which is incorporated herein by reference.

### BACKGROUND

Mattresses are often sold in retail showrooms. Typically, the mattresses displayed in the retail showrooms are accompanied with various types of displays to showcase information related to the prospective mattress. Displays may come in many forms, such as signage located around, near or on the mattress itself. In some instances, the displays are incorporated into the bedding associated with the mattress such as foot protectors, pillow cases, and the like.

Information related to a mattress can vary drastically for each product being sold. Thus, for large retail showrooms, hundreds and thousands of displays may be required.

Therefore a need exists for providing mattress displays that allow for easy display of information associated with the mattress being sold on the retail showroom.

### SUMMARY

The following presents a simplified summary of several embodiments of the invention relating to a mattress display that allow for easy, interchangeable displaying of information associated with a mattress. The mattress display may have first and second panels that are removably coupled to one another for interchangeability. The second panel may have various types of information, permanently or temporarily displayed on at least one of its sides. For example in one embodiment, a mattress display is provided as a foot protector where the foot protector is draped across the foot of a mattress and has a second panel affixed to a first panel of the foot protector with the use of a zipper and located in the center of the first panel. In another embodiment, a mattress display is provided as a foot protector where the foot protector is draped across the foot of a mattress and has a second panel affixed to a first panel of the foot protector with the use of a zipper and located across the width of the mattress. In yet another embodiment, a mattress display is provided as a pillow case where the pillow case is positioned across the head of a mattress and has a second panel affixed to a first panel of the pillow case with the use of a zipper.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a perspective view of a first embodiment of a mattress display with a removable portion according to the present invention;

FIG. 2 is an exploded, front view of the mattress display with a removable portion of FIG. 1 viewed from an upper perspective, with the removable portion in a closed position;

FIG. 3 is an exploded, right side view of the mattress display with removable portion of FIG. 1 viewed from an upper perspective, with the removable portion in an open position;

FIG. 4 is a perspective view of a second embodiment of a mattress display with removable portion according to the present invention;

FIG. 5 is an exploded, front view of the mattress display with removable portion of FIG. 4 viewed from an upper perspective, with the removable portion in a closed position;

FIG. 6 is an exploded, right side view of the mattress display with removable portion of FIG. 4 viewed from an upper perspective, with the removable portion in an open position;

FIG. 7 is a perspective view of a third embodiment of a mattress display with removable portion according to the present invention;

FIG. 8 is an exploded view of the mattress display with removable portion of FIG. 8 viewed from an upper perspective, with the removable portion in an open position; and

FIG. 9 provides a flow diagram illustrating a method for providing a mattress display, according to an embodiment of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

It is noted that the mattress displays described herein are described in an in-use or deployed environment as opposed to a stored environment. Thus, the description below should not limit an understanding of the mattress displays in a folded, stored environment. For example, sides of the mattress displays may be illustrated and described below as in a parallel orientation when in the deployed environment, but it is understood that the sides may be in a different orientation when folded and stored. Furthermore, it should be noted that the mattress display may be deployed in other furniture embodiment, not inclusive of types of mattresses. Other furniture embodiments may include but not be limited to box springs, bed frames, dressers, armoires, chairs, tables, desks, and/or the like.

Embodiments of the invention relate to methods and apparatuses for providing a mattress display, wherein the mattress display may have a removable portion for use in displaying information.

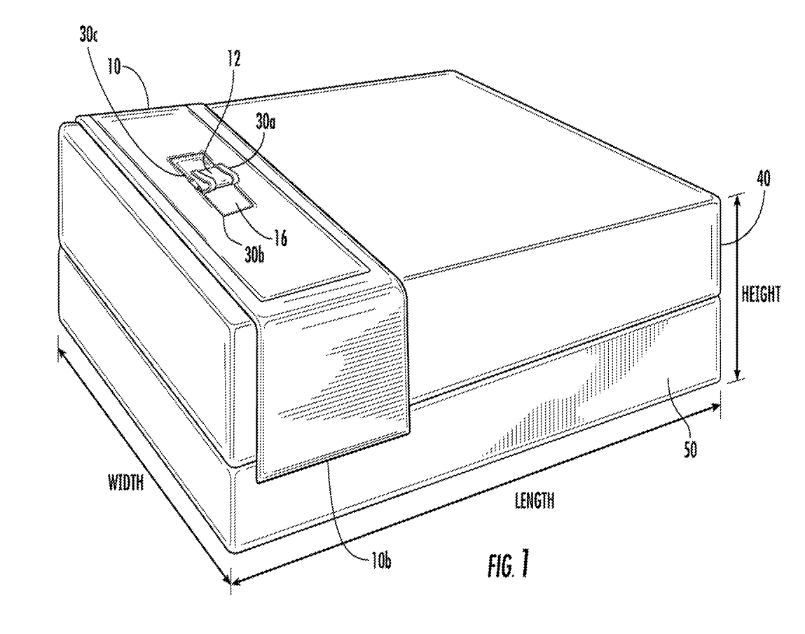

As illustrated in FIGS. 1-8, a second panel 12, 14, 22 is removably attached to a first panel 10 of a mattress display, where the mattress display may be positioned on top of a mattress 40, wherein the top of the mattress, as described herein includes one or more sides of the mattress that an individual would lay on. The first panel 10 is defined by a body comprising a top and bottom surface, and a first attachment region 30b having a first perimeter. The second panel is defined by a body having a second perimeter and comprising a first and second side, and a second attachment region 30a having a third perimeter.

The mattress display may be manufactured from a plurality of textiles, including, but not limited to, textiles such as cotton (including, but not limited to, appliques, chintz, denim, felt, flannel, canvas, blends), linen, leather, lace, mohair, nylon, polyester, rayon, satin, silk, suede, tulle, ultra suede, ribbon (including, but not limited to, grosgrain, nylon, organza, polyester, satin, silk, blends and the like), plastic and the like. The mattress display may be manufactured from any fabric and/or materials suitable for mattress displays. The mattress display may be manufactured in various shapes, including, but not limited to, rectangles, squares, circles, triangles, polygons, letters, and the like.

The second panel 12, 14, 22 may be removably attached to the first panel 10 of the mattress display via an attachment region 30. The attachment region may collectively consist of a first attachment region 30b associated with the first panel 10 and a second attachment region 30a associated with the second panel 12, 14, 22 that work operatively together to removably couple the first panel 10 to the second panel 12, 14, 22. The second panel 12, 14, 22 may be attached to the first panel 10 of the mattress display in a variety of ways, including, but not limited to, zippers, magnets, adhesive, Velcro®, buttons, clasps, snaps, straps, hock, eyelets, and the like. In one embodiment, the attachment region 30 comprises a zipper. The zipper may consist of a first and second half of the zipper (e.g. two rows of protruding teeth) and a slider for joining the first and second halves of the zipper to one another. The zipper may be a coil zipper, invisible zipper, metallic zipper, plastic-molder zipper, open-ended zipper, closed-ended zipper, and the like.

The second panel 12, 14, 22 may be bordered by the second attachment region 30a such that the second attachment region 30a is located along at least a portion of the perimeter of the second panel 12, 14, 22. In such an embodiment, the second panel 12, 14, 22 and the second attachment region 30a may have a perimeter equal in size. For example, the second attachment region 30a may be a first row of protruding teeth of a zipper. As illustrated in at least FIG. 1, the second attachment region 30a is located along the perimeter of the second panel 12, 14, 22 and both the second attachment region 30a and the second panel 12, 14, 22 have equivalent perimeter sizes. In an alternative embodiment, the second attachment region 30a may have a perimeter size that is smaller than the perimeter size of the second panel 12, 14, 22. In such an embodiment the second attachment region may not be visible as it may be covered by the second panel 12, 14, 22 overlaying its perimeter. The second panel 12, 14, 22 may comprise an additional piece of material that extends from the second panel 12, 14, 22 and overlays both the first and second attachment regions 30b, 30a respectively, thus serving as a flap or tab to cover both the first and second attachment regions 30b, 30a respectively.

At least a portion of the first panel 10 may be bordered by the first attachment region 30b such that the first attachment region 30b is at least partially located along a portion of the first panel 10. In the illustrated embodiments, the top surface of the first panel 10 may comprise a display base 16, in which the display base serves as the portion of the first panel 10 to be bordered at least partially by the first attachment region 30b. For example the first attachment region 30b may be a second row of protruding teeth of a zipper. In such an embodiment, the display base 16 is bordered by the first attachment region 30b, and a slider 30c is attached to the display base 16 to aid in joining the first and second attachment regions 30b, 30a, respectively. The second panel 12, 14, 22 may be affixed to the first panel 10 by joining the first and second attachment regions 30b, 30a respectively such that the second panel 12, 14, 22 is adjacent to the display base 16 of the first panel 10. The first panel 10 may comprise an additional piece of material that extends from the first panel 10 and overlays both the first and second attachment regions 30b, 30a respectively, thus serving as a flap or tab to cover both the first and second attachment regions 30b, 30a respectively. In one embodiment, the display base 16 may serve as a portion of the first attachment region 30b. For example, the first attachment region 30b may be adhesive where the adhesive is located along the perimeter of the first attachment region 30b and at least a portion of the display base 16.

The second panel 12, 14, 22 may be manufactured from a plurality of textiles, including, but not limited to, textiles such as cotton (including, but not limited to, appliques, chintz, denim, felt, flannel, canvas, blends), linen, leather, lace, mohair, nylon, polyester, rayon, satin, silk, suede, tulle, ultra suede, ribbon (including, but not limited to, grosgrain, nylon, organza, polyester, satin, silk, blends and the like), plastic and the like. The second panel 12, 14, 22 may be manufactured from any fabric and/or materials suitable for mattress displays. The second panel 12, 14, 22 may be manufactured in various shapes, including, but not limited to, rectangles, squares, circles, triangles, polygons, letters and the like. In one embodiment, the size of the second panel may be smaller than the size of the first panel. In an alternative embodiment, both the first and second panels may be the same size. In one embodiment, the second panel may be the same shape as the first panel. For example, the first panel may be a large rectangle and the second panel may be a small rectangle that fits within the first panel. In an alternative embodiment, the second panel may be a different shape from the first panel. For example the first panel may be a large rectangle and the second panel may be a small rectangle that fits within the first panel.

The second panel 12, 14, 22 contains information that may be either permanently or temporarily displayed on the second panel 12, 14, 22. Information may be displayed along the width of the second panel 12, 14, 22. Information may also be displayed along the length of the second panel 12, 14, 22. In one embodiment, information may include marketing information, such as the mattress manufacturer's name and logo. In another embodiment, information may include product specifications, such as the mattress dimensions. In yet another embodiment, information may include product sales information, such as the mattress price. Information may also include pictures, logos, and the like. Means for permanently displaying information may include but not be limited to screen printing, embroidering, painting, and the like. Means for temporarily displaying information may include but not be limited to the use of dry erase markers, chalk, erasable ink, digital signage, Velcro® banners, magnetic lettering, and the like. In one embodiment, information may be displayed on only one side of the second panel 12, 14, 22, such as the first side, such that the information is visible to a customer when the second panel 12, 14, 22 is in a closed and/or zipped embodiment. In another embodiment, information may be displayed on both sides of the second panel 12, 14, 22 such that the second panel 12, 14, 22 is reversible. In such an embodiment, only information located on the side of the second panel 12, 14, 22 which is facing away from the display base 16 may be visible to a customer when the second panel 12, 14, 22 is in a closed and/or zipped embodiment. Furthermore, in such an embodiment, information located on the side of the second panel 12, 14, 22 which is facing the display base 16 is hidden to a customer when the second panel 12, 14, 22 is in a closed and/or zipped embodiment. The display base 16 may contain additional information such that when the second panel 12, 14, 22 is completely removed the information may be visible to a customer. With reference to FIGS. 1-6, an embodiment of a mattress display with a second panel 12, 14 removably coupled to a first panel 10 of the mattress display is illustrated according to one embodiment of the present invention. In one embodiment, the mattress display may cover an entire mattress 40. In one embodiment, the mattress display may be a foot protector comprising a first panel 10 and a second panel 12, 14 removably coupled to one another. The foot protector may be draped across the foot of a mattress 40 positioned directly above a box spring 50, with respect to the width of the mattress 40 and box spring 50. In one embodiment, the foot protector may cover at least a portion of both the mattress 40 and the box spring 50. In another embodiment, the foot protector may only cover at least a portion of the mattress 40. In one embodiment, the foot protector is the same width as the mattress 40 and the box spring 50. In another embodiment, the foot protector is a width greater than the width of the mattress 40 and the box spring 50 such that the ends of the first panel 10 of the foot protector 10a, 10b can be tucked under the mattress 40. In one embodiment, the ends of first panel 10 of the foot protector 10a, 10b may be tucked under the mattress 40 and mechanically fastened to one another. Means for mechanically fastening the ends of the foot protector 10a, 10b may include but not be limited to buttons, zippers, magnets, adhesive, Velcro®, bungee cords, mechanical locks, drawstrings, buckles, fasteners, clasps, snaps, straps, hock, eyelets, and the like and the like. The foot protector may be designed in a plurality of shape and sizes such that it fits various types of mattresses. The foot protector may be manufactured in various shapes including but not limited to, rectangles, squares, circles, triangles, polygons, letters and the like. The foot protector may fit various mattress sizes, including but not limited to, twin, twin XL, full, queen, king, and California king sized mattresses. A standard Crib mattress size may be 28 inches by 52 inches. A standard Twin mattress size (e.g. single) may be 39 inches by 75 inches. A standard Full mattress size (e.g. double) may be 54 inches by 75 inches. A standard long twin mattress size may be 36 inches by 80 inches. A standard Queen Mattress size may be 60 inches by 80 inches. A standard King Mattress size may be 54 inches by 75 inches. A standard California King Mattress size may be 72 inches by 84 inches.

The foot protector may also comprise a decorative hem and/or stitching along the perimeter. The foot protector may be flexible such that it conforms to any shape and/or sized mattress. The foot protector may be manufactured from a plurality of textiles, including, but not limited to, textiles such as cotton (including, but not limited to, appliques, chintz, denim, felt, flannel, canvas, blends), linen, leather, lace, mohair, nylon, polyester, rayon, satin, silk, suede, tulle, ultra suede, ribbon (including, but not limited to grosgrain, nylon, organza, polyester, satin, silk, blends and the like), plastic and the like. The foot protector 10 may be manufactured from any fabric and/or materials suitable for mattress displays. In one embodiment, the first panel 10 of the foot protector is manufactured using the same textile of the second panel 12, 14. In another embodiment, the first panel 10 of the foot protector is manufactured using a different textile than the second panel 12, 14.

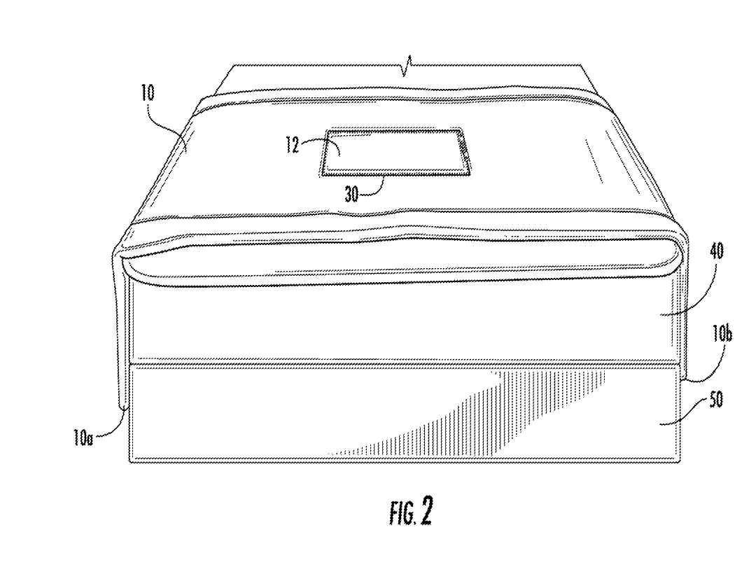

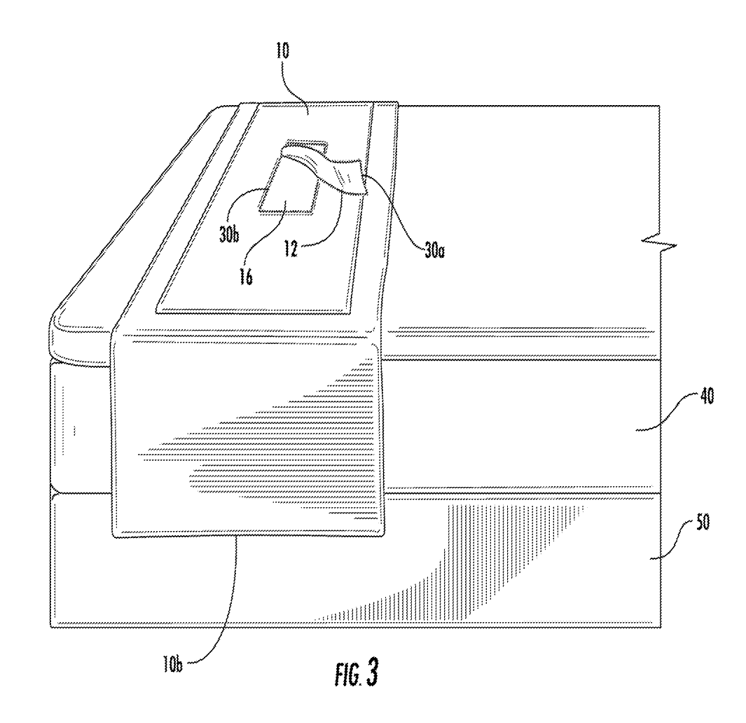

With reference to FIGS. 1-3, a mattress display with a second panel 12 removably coupled to a first panel 10 is illustrated according to one embodiment of the present invention. As shown in FIGS. 1-3, the mattress display is a foot protector having a second panel 12 located in the center of the first panel 10 of the foot protector on top of the display base 16 and operatively attached thereto via attachment region 30 with the use of a zipper. The foot protector drapes over the foot of the mattress 40 along the width of the mattress 40 and the box spring 50 such that the ends of the first panel of the foot protector 10a, 10b cover at least a portion of both the tops and sides of mattress 40 and the sides of box spring 50. In such an embodiment, the second panel 12 does not extend across the full width of the mattress 40. The second panel 12 may be located in various positions of the foot protector. The various positions may include, but not be limited to, the center, right side, left side, top, bottom, and/or the like. FIG. 1 illustrates the second panel 12 in a partially open embodiment, such that the second attachment region 30a and the first attachment region 30b are partially affixed to one another, two sides of the second panel 12 are partially visible, the zipper is partially zipped, and the display base 16 is partially exposed. FIG. 2 illustrates the second panel 12 in a closed embodiment, such that the second attachment region 30a and the first attachment region 30b are completely affixed to one another, only one side of the second panel 12 is visible, the zipper is completely zipped, and the display base 16 is not exposed. In some embodiments, a flap or tab may cover the zipped portion. FIG. 3 illustrates the second panel 12 in an open embodiment, such that the second attachment region 30a and the first attachment region 30b are not affixed to one another, both sides of the second panel 12 are visible, the zipper 30 is completely unzipped, and the display base 16 is fully exposed.

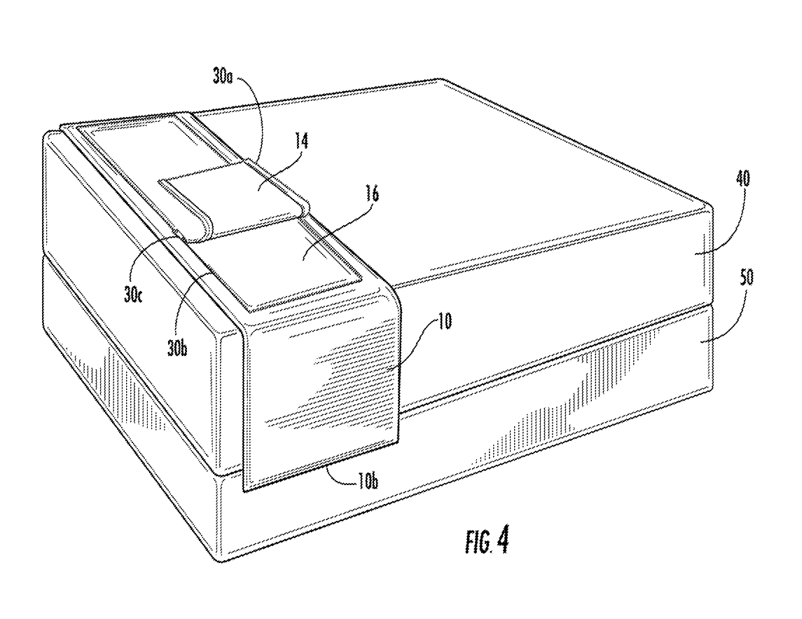

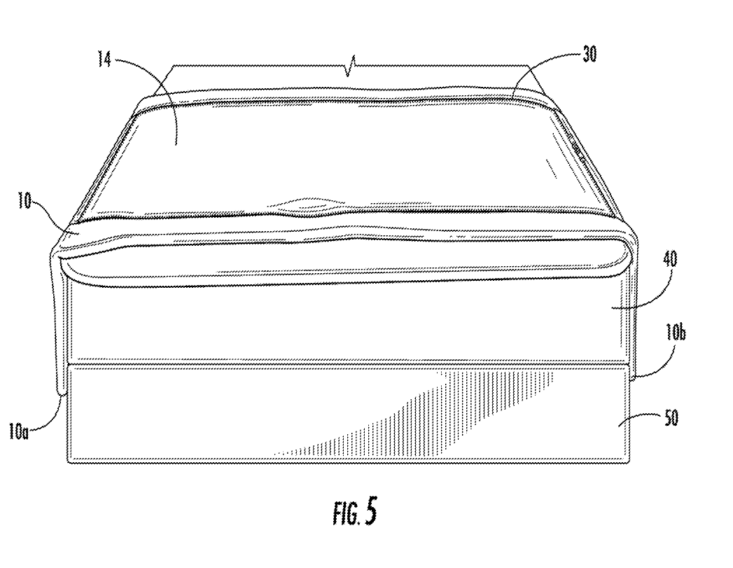

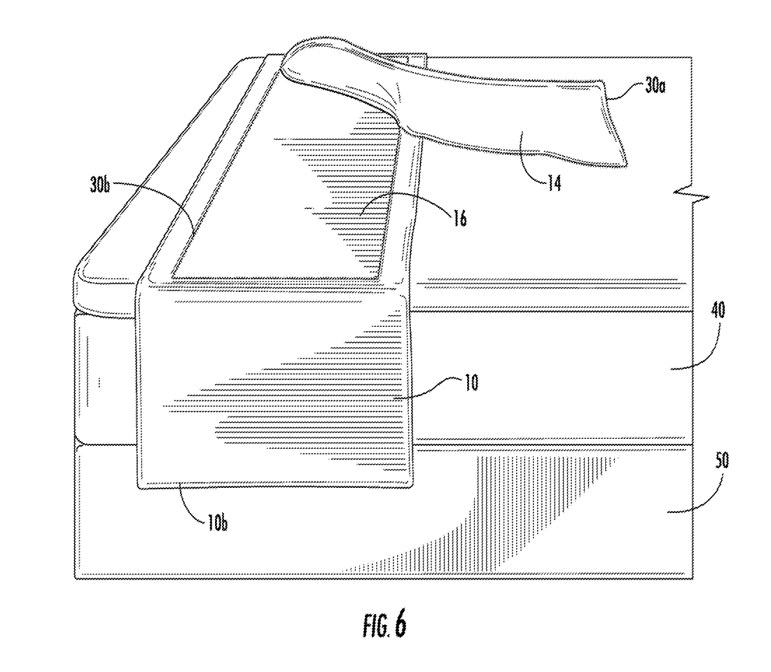

With reference to FIGS. 4-6 a mattress display with a second panel 14 removably coupled to a first panel 10 is illustrated according to one embodiment of the present invention. As shown in FIGS. 4-6, the mattress display is a foot protector having a second panel 12 positioned adjacent to the display base 16 of the first panel 10, and operatively attached thereto via attachment region 30 with the use of a zipper. The foot protector drapes over the foot of the mattress 40 along the width of the mattress 40 and the box spring 50 such that the ends of the first panel of foot protector 10a, 10b cover at least a portion of both the tops and sides of mattress 40 and the sides of box spring 50. In such an embodiment, the second panel 14 extends across the full width of the mattress 40 but does not extend to the sides of the mattress. In one embodiment, the second panel 14 may further extend to the sides of the mattress 40 such that is extend from one of the end of the first panel 10a to another end of the first panel 10b. FIG. 4 illustrates the second panel 14 in a partially open embodiment, such that the second attachment region 30a and the first attachment region 30b are partially affixed to one another, two sides of the second panel 14 are partially visible, the zipper is partially zipped, and the display base 16 is partially exposed. FIG. 5 illustrates the second panel 14 in a closed embodiment, such that the second attachment region 30a and the first attachment region 30b are completely affixed to one another, only one side of the second panel 14 is visible, the zipper 30 is completely zipped, and the display base 16 is not exposed. FIG. 6 illustrates the second panel 14 in an open embodiment, such that the second attachment region 30a and the first attachment region 30b are not affixed to one another, both sides of the second panel 14 are visible, the zipper is completely unzipped, and the display base 16 is fully exposed.

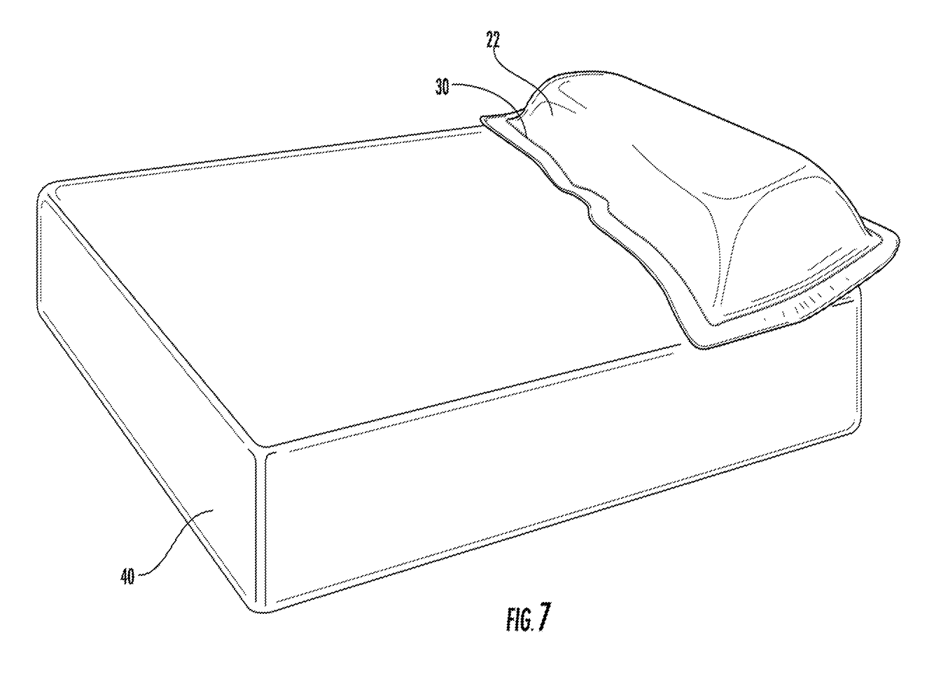

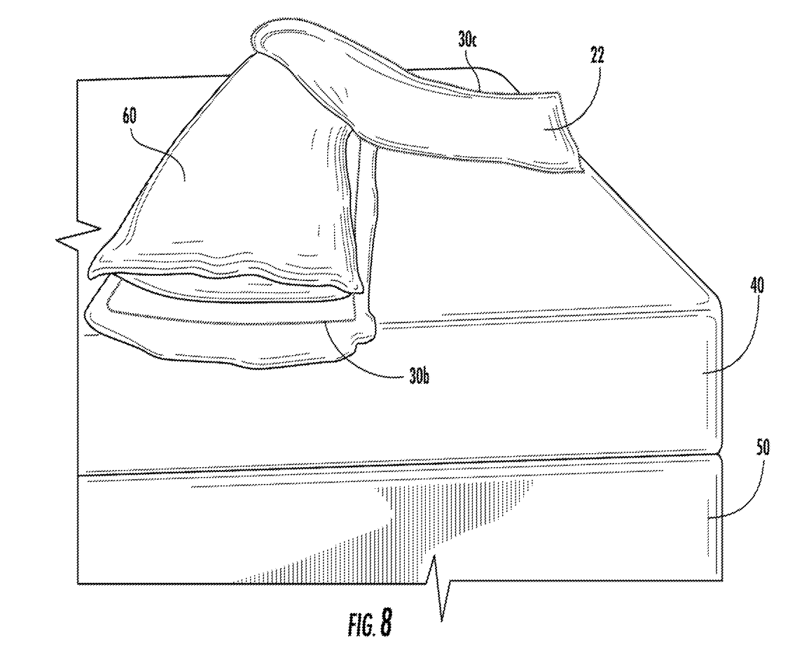

With reference to FIGS. 7 and 8 a mattress display with a second panel 22 removably coupled to a first panel 10 is illustrated according to one embodiment of the present invention. In one embodiment the mattress display may be a pillow case. The pillow case may be positioned across the head of a mattress 40 with respect to the width of the mattress 40 and box spring 50. In one embodiment, the pillow case may cover at least a portion of the top of the mattress 40. In one embodiment, the pillow case 20 is the same width as the mattress 40 and the box spring 50. In another embodiment, the protector 10 is a width less than the width of the mattress 40 and the box spring 50 such that the ends of do not extend to the ends of the mattress 40. In one embodiment, the pillow case may be mechanically fastened to the mattress 40 top. Means for mechanically fastening the pillow case may include but not be limited to buttons, zippers, magnets, adhesive, Velcro®, bungee cords, mechanical locks, drawstrings, buckles, fasteners, clasps, snaps, straps, hock, eyelets, and the like and the like. The pillow case may be designed in a plurality of shape and sizes. The pillow case 20 may be manufactured in various shapes including but not limited to, rectangles, squares, circles, triangles, polygons, letters and the like. The pillow case may also comprise a decorative hem and/or stitching along the perimeter. The pillow case may be flexible such that it conforms to any shape and/or sized pillow 60. The pillow case may be manufactured from a plurality of textiles, including but not limited to, textiles such as cotton (including, but not limited to, appliques, chintz, denim, felt, flannel, canvas, blends), linen, leather, lace, mohair, nylon, polyester, rayon, satin, silk, suede, tulle, ultra suede, ribbon (including, but not limited to grosgrain, nylon, organza, polyester, satin, silk, blends and the like), plastic and the like. The pillow case may be manufactured from any fabric and/or materials suitable for mattress displays. In one embodiment, the pillow case is manufactured using the same textile of the second panel 22. In another embodiment, the pillow case is manufactured using a different textile than the second panel 22.

As shown in FIGS. 7 and 8, the mattress display is a pillow case having a second panel 22 located adjacent to the display base 16 of the first panel 10 and operatively attached thereto via the attachment region 30 with the use of a zipper. In such an embodiment, the display base 16 may be the inside of the pillow case. In another embodiment, the display base 16 may be the upper surface of the pillow case. The pillow case is placed along the head of the mattress 40 with respect to the width of the mattress 40 and the box spring 50 such that the pillow case covers at least a portion of the top of the mattress 40. The pillow case may be placed in any position about the top of the mattress 40. FIG. 7 illustrates the second panel 22 in a closed embodiment, such that the second attachment region 30a and the first attachment region 30b are completely affixed to one another, only one side of the second panel 22 is visible, the zipper is completely zipped, the pillow 60 is not visible, and the display base 16 is not exposed. FIG. 7 illustrates the second panel 22 in an open embodiment, such that the second attachment region 30a and the first attachment region 30b are not affixed to one another, both sides of the second panel 22 are visible, the zipper 30 is completely unzipped, the pillow 60 is exposed and the display base 16 is fully exposed. In such an embodiment, the display base 16 may be exposed but not visible as the pillow 60 rest on top of the display base 16. In an alternative embodiment, the pillow 60 may be removed and the display base 16 is completely exposed. The pillow case may also be used in a partially opened embodiment, such that the second attachment region 30a and the first attachment region 30b are partially affixed to one another, two sides of the second panel 14 are partially visible, the zipper 30 is partially unzipped, the pillow 60 is partially exposed and removable, and the display base 16 is partially exposed.

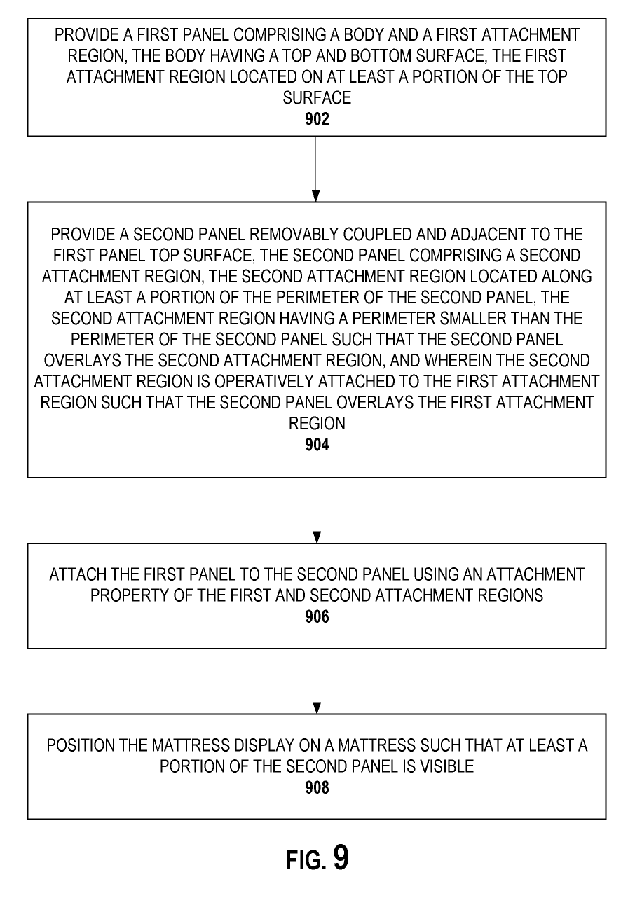

Now referring to FIG. 9, a method for providing a mattress display according to the present invention is provided. As shown at event 902 a first panel is initially provided. The first panel may comprise a body and a first attachment region. In one embodiment, the body of the first panel is defined by a top and bottom surface. The first attachment region may be located on at least a portion of the first panel's top surface. As shown at event 904 a second panel is then provided. The second panel may be removably coupled and adjacent to the top surface of the first panel. The second panel may comprise a second attachment region, where the second attachment region is separate and distinct from the first attachment region. In one embodiment, the second attachment region located along at least a portion of the perimeter of the second panel. The second attachment region may have a perimeter size that is smaller than the perimeter size of the second panel such that the second panel overlays the second attachment region. In one embodiment, the second attachment region is operatively attached to the first attachment region such that the second panel overlays the first attachment region. As shown at event 904, the method further includes attaching the first panel to the second panel using an attachment property of the first and second attachment regions. At event 906, the mattress display is positioned on a mattress such that at least a portion of the second panel is visible.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A mattress display, the mattress display comprising:
a first panel comprising a body, the body having a top and bottom surface, wherein the first panel is positioned on a mattress, wherein the top surface of the body comprises a display base, wherein the display base is defined by a first display;
a second panel comprising a top surface and a bottom surface, wherein the top surface of the second panel is defined by a second display, wherein the bottom surface of the second panel is defined by a third display such that the second panel is reversible, wherein the second panel is removably coupled and adjacent to the display base of the first panel, wherein a perimeter of the second panel is smaller than a perimeter of the first panel; and
a plurality of attachment regions, the plurality of attachment regions comprising:
a first attachment region associated with the first panel, the first attachment region comprising one or more attachment properties, the first attachment region located on at least a portion of the first panel top surface and inside the perimeter of the first panel, and
a second attachment region associated with the second panel, the second attachment region comprising the one or more attachment properties, wherein the second attachment region is operatively attached to the first attachment region, and wherein the perimeter of the second panel is larger than a perimeter of the second attachment region, such that the second panel overlays the first and the second attachment regions when the first and the second attachment regions are operatively attached.

2. The mattress display of claim 1, wherein the first panel comprises an additional piece of material that overlays the first and second attachment regions.

3. The mattress display of claim 1, wherein the top surface of the second panel and the second display are visible when the first panel and the second panel are attached such that the bottom surface of the second panel is adjacent to the top surface of the first panel, and
wherein the bottom surface of the second panel and the third display are visible when the first panel and the second panel are attached such that the top surface of the second panel is adjacent to the top surface of the first panel.

4. The mattress display of claim 1, wherein the first panel is not a pocket configured to receive one or more inserts.

5. The mattress display of claim 1, wherein the second attachment region and the first attachment region are partially affixed to one another, such that the second display is visible when the bottom surface of the second panel is adjacent to the top surface of the first panel, and both the first display and the third display are visible when the second panel is flipped so that the top surface of the second panel is adjacent to the top surface of the first panel.

6. The mattress display of claim 1, wherein the second panel extends from a first end of the first panel to a second end of the first panel when attached to the first panel.

7. The mattress display of claim 1, wherein the mattress display is a foot protector.

8. The mattress display of claim 1, wherein the mattress display is rectangular in shape, and wherein dimensions of the mattress display are eighteen inches (18) wide by seventy-six inches (76) long.

9. The mattress display of claim 1, wherein the mattress display is a pillow case.

10. The mattress display of claim 1, wherein the mattress display is rectangular in shape, and wherein dimensions of the mattress display are twenty inches (20) wide by thirty-six inches (36) long.

11. The mattress display of claim 1, wherein the mattress display is round in shape, and wherein a diameter of the mattress display is twenty inches (20).

12. The mattress display of claim 1, wherein the first attachment region comprises a first half of a zipper located on at least a portion of the-perimeter of the first panel, wherein the second attachment region comprises a second half of the zipper located on at least a portion of the perimeter of the second panel, and wherein joining the first and second halves of the zipper cause the first panel to attach to the second panel.

13. A mattress display, the mattress display comprising:
a first panel comprising a body, the body having a top and bottom surface, wherein the first panel is positioned on a mattress, wherein the top surface of the body comprises a display base, wherein the display base is defined by a first display;
a second panel comprising a top surface and a bottom surface, wherein the second panel is removably coupled and adjacent to the first panel top surface, wherein the top surface of the second panel is defined by a second display and the bottom surface of the second panel is defined by a third display such that the second panel is reversible, wherein a perimeter of the second panel is smaller than a perimeter of the first panel,
wherein the top surface of the second panel and the second display are visible when the first panel and the second panel are attached such that the bottom surface of the second panel is adjacent to the top surface of the first panel, and the perimeter of the second panel lies completely within the perimeter of the first panel,
wherein the bottom surface of the second panel and the third display are visible when the first panel and the second panel are attached such that the top surface of the second panel is adjacent to the top surface of the first panel; and
a plurality of attachment regions, the plurality of attachment regions comprising:
a first attachment region associated with the first panel, the first attachment region comprising an attachment property, the first attachment region located on at least a portion of the first panel top surface, wherein the attachment property is a zipper, and wherein the first attachment region comprises a first portion of the zipper, and
a second attachment region associated with the second panel, the second attachment region comprising the attachment property, the second attachment region located on at least one surface of the second panel, wherein the second attachment property comprises a second portion of the zipper, and wherein the second attachment region is operatively attached to the first attachment region, wherein the second attachment region is operatively attached to the first attachment region, wherein the perimeter of the second panel is larger than the perimeter of the second attachment region such that the second panel overlays the first and the second attachment regions when the first and the second attachment regions are operatively attached.

14. The mattress display of claim 13, wherein the first panel comprises an additional piece of material that overlays the first and second attachment regions.

15. The mattress display of claim 13, wherein the mattress display is a foot protector.

16. The mattress display of claim 13, wherein the mattress display is rectangular in shape, and wherein dimensions of the mattress display are eighteen inches (18) wide by seventy-six inches (76) long.

17. The mattress display of claim 13, wherein the mattress display is a pillow case.

18. The mattress display of claim 13, wherein the mattress display is rectangular in shape, and wherein dimensions of the mattress display are twenty inches (20) wide by thirty-six inches (36) long.

19. The mattress display of claim 13, wherein the mattress display is round in shape, and wherein a diameter of the mattress display is twenty inches (20).

20. A method for providing a mattress display, the method comprising:
providing a first panel comprising a body and a first attachment region, the body having a top surface and a bottom surface, the first attachment region located on at least a portion of the top surface, wherein the first panel is positioned on a mattress, wherein the top surface of the body comprises a display base, wherein the display base is defined by a first display;
providing a second panel comprising a top surface and a bottom surface, wherein the top surface of the second panel is defined by a second display and the bottom surface of the second panel is defined by a third display such that the second panel is reversible, wherein the second panel is removably coupled and adjacent to the top surface of the first panel, wherein a perimeter of the second panel is smaller than a perimeter of the first panel, the second panel comprising a second attachment region, the second attachment region located on one surface of the second panel, wherein the second attachment region is operatively attached to the first attachment region,
wherein the top surface of the second panel and the first display are visible when the first panel and the second panel are attached such that the bottom surface of the second panel is adjacent to the top surface of the first panel,
wherein the bottom surface of the second panel and the second display are visible when the first panel and the second panel are attached such that the top surface of the second panel is adjacent to the top surface of the first panel;
attaching the first panel to the second panel using one or more attachment properties of the first and second attachment regions; and
positioning the mattress display on a mattress such that at least a portion of the second panel is visible.
